(19) United States
(12) Patent Application Publication
(10) Pub. No.: US 2008/0305742 A1
(43) Pub. Date: Dec. 11, 2008

(54) INTERFACE FOR PDA AND COMPUTING DEVICE

(76) Inventor: Otman A. Basir, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 12/135,646

(22) Filed: Jun. 9, 2008

Related U.S. Application Data
(60) Provisional application No. 60/942,505, filed on Jun. 7, 2007.

(51) Int. Cl. H04B 7/00

(52) U.S. Cl. 455/41.2

(57) ABSTRACT

An interface between PDAs and computing devices, such as a PC or an in-vehicle system permits a user to use the better user interface of the computing device to access and control the operation of the PDA.

This application claims priority to U.S. Provisional Application Ser. No. 60/942,505, filed Jun. 7, 2007.

### BACKGROUND

Mobile email/contact/calendar devices, such as “smartphones,” wireless-enabled PDAs, etc., (collectively referred to as “PDAs”) are a convenient way for people to stay connected when traveling, in meetings and on the road. Email, contacts and calendar entries are cached on the PDA and synced with a server via a wireless connection. Users can send and receive email, update contacts and add or changes calendar appointments, which updates are stored on the server. However, PDAs have several limitations. The limited keyboard and display make it difficult to compose large emails or other documents. The PDAs often cannot open all types of documents, especially larger or more complex documents.

### SUMMARY

The present invention provides an interface between PDAs and computing devices, such as a PC or an in-vehicle system. The interface permits a user to use the better user interface of the computing device to access and control the operation of the PDA.

### BRIEF DESCRIPTION OF THE DRAWINGS

FIG. 1 illustrates a PDA communicating with a laptop computing device using the interface of the present invention.

FIG. 2 illustrates the PDA communicating with an in-vehicle computing system using the interface of the present invention.

FIG. 3 is a schematic of the interface of FIGS. 1 and 2.

### DESCRIPTION OF A PREFERRED EMBODIMENT

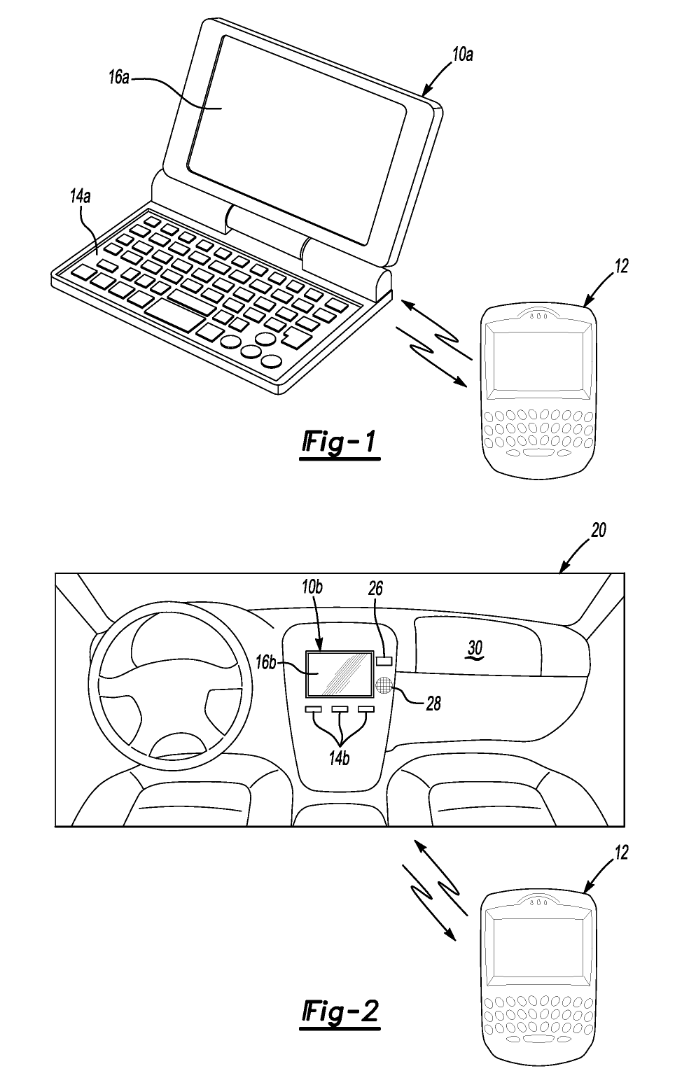

Referring to FIG. 1, a PC 10a includes a keyboard 14a and a display 16a that are much larger than those of a PDA 12. The PC 10a is a general purpose computer with a processor, memory, storage (such as hard drive or other electronic, optical, magnetic or other mass storage). The PC 10a also typically has a more powerful processor and more memory and storage. Although a laptop or notebook computer is shown, the PC 10a could also be a desktop computer.

The PDA 12 is a “smartphone” or PDA with wireless connectivity. In this context, “PDA” means a mobile device having at least a processor, local storage, local wireless connectivity (e.g. Bluetooth or similar) and wireless data connectivity via cell towers or satellite or some other wide area network. The PDA 12 may also provide voice wireless connectivity (i.e. telephone functions) and may also include a display and user input device (such as telephone keys or a mini-keyboard or on-screen soft keys).

In the present invention, software is installed on the PC 10a and the PDA 12 to communicate wirelessly (Bluetooth, WiFi, or other suitable protocol, preferably secure) with one another. Alternatively, or optionally, they can be connected via a wire, such as a USB cable, for increased speed and security. The PDA software will connect with the PC software to provide the PC 10a real-time access to information on PDA 12. It will also monitor PDA activities and will alert the PC software of new email messages arriving on the PDA 12, calendar events, sms, phone calls with (caller id), etc. The PC 10a software will provide a user interface to PDA 12 contents and alerts through a user-friendly interface residing on the PC 10a. The user will be able to see a real-time image of PDA 12 information content, including, emails: sent, received, sms, phone calls, etc.

For example, new emails arriving on PDA 12 will show immediately on PC 10a software interface. The user can open the new emails using the PC 10a, along with previously-received emails that exist on the PDA 12. The user can also open any attachments using PC 10 resident software (Microsoft Office, PowerPoint, Word, Acrobat, etc) to open and manipulate attachments. The user can respond to emails using the PC 10a and can attach documents from the PC 10a. The outcome of all activities are mirrored and executed in real-time on the PDA 12 and as such the PDA 12 will execute the responses as if it they were initiated on the PDA 12. For instance, as soon as a new email arrives at the PDA 12, a copy of the email is immediately presented on the PC 10a software. The user can open the email and attachments (if any), and reply to the email using the larger display and keyboard on the PC 10a, rather than the PDA 12.

The PC 10a software will communicate the response of the user to the PDA 12. The PDA 12 in turn will send the response as if it was initiated from within the PDA 12 using its wireless module, and logs it in its mailbox activities as a sent reply. Similarly, the user can initiate on the PC 10a software a new message to a recipient (new contact or a contact from the PDA 12 contact list). The user can use PC 10a resident software applications to compose the message, and or attachments, and press send. The send command will cause the message to be communicated to the PDA 12 which will send the email and log the message as a sent message on its mailbox file structure.

The user can also use the PC software to compose an sms message (or similar message format) to a person on the contact list and can also respond to sms messages. When a new call arrives on PDA 12, the caller id is displayed on the display 16a of the PC 10a. The user can execute PDA resident web browsers and use the larger display 16a for browsing the web.

With this invention, the PC 10a does not need to have internet connectivity or wifi connectivity to the internet. It just needs to have a wireless or a wired connection to the PDA 12. The user can enjoy the PDA 12 wireless connectivity and at the same time take advantage of the larger PC display 16a, keyboard 14a, and PC-resident software apps, without the need to pay for another wireless service for his/her PC 10a.

In a first mode of operation, the information on the PDA 12 (contacts, calendar, emails, media files such as mp3s, mpegs, etc) is sent to the PC 10a as requested by the PC 10a for review by the user on the display 16a and/or modification with the keyboard 14a (and/or mouse or other user input devices). For example, the PDA 12 sends a list of emails in the user's inbox when so requested by the PC 10a, and only after one of the emails has been selected by the user (via the user input devices on the PC 10a) is that email sent to the PC 10a. However, as the email is modified or forwarded or replied to by the user on the PC 10a, the modified email (or forward or reply) is transmitted to the PDA 12 and is actually sent from the relevant program in the PDA 12, such that for all intents, purposes and outward appearances, the email was sent by the PDA 12.

In a second mode of operation, the PC 10a acts only as a “dumb” terminal for the PDA 12. The PC 10a receives information to display on display 16a from PDA 12, and the PC 10a sends user inputs from the keyboard 14a (or other user input devices) directly to the PDA 12 to be processed by the processor of the PDA 12. In this mode, the user's information is more secure, since none of it is stored on the PC 10a; however, the user does not gain the advantage of the increased processing power of the PC 10a. This would be appropriate when using a public PC 10a or someone else's PC 10a.

Preferably, the user can choose the first mode or the second mode with the PDA 12, as appropriate in a given situation. When working on his own PC 10a, he can work in the first mode for increased power and speed, and when working on a PC 10a that is not his own he can work in the second mode for security (while still enjoying the improved interface with the larger display 16a and keyboard 14a or other user input devices).

In either mode, the access to the data on the PDA 12 is in real-time. There is no need to wait for the devices to synchronize.

As shown in FIG. 2, the invention could also be implemented in a vehicle 20. The in-vehicle system 10b includes a display 16b (such as a touch-screen display), user input devices 14b (such as button, joysticks, etc). The in-vehicle system 10b may also include a microphone 26 and speaker 28 so that user speech recognition, user voice commands and speech feedback from the system 10b can be provided. In this manner, the user can access and control the PDA 12 with the system 10b in the vehicle 20. The user can control the PDA 12 with the user input devices 14b and view data from the PDA 12 on the display 16b in a manner similar to that described above with respect to FIG. 1. Additionally, the user can give voice commands, which are processed by the system 10b and converted to commands to be sent to the PDA 12. The user can further dictate emails or text messages to be sent by the PDA 12 using the voice recognition of the system 10b. Additionally, the information from the PDA 12 can be converted from text to speech and read to the user by the system 10b via the speaker 28. The system 10b can also be operated in either the first or second modes described above.

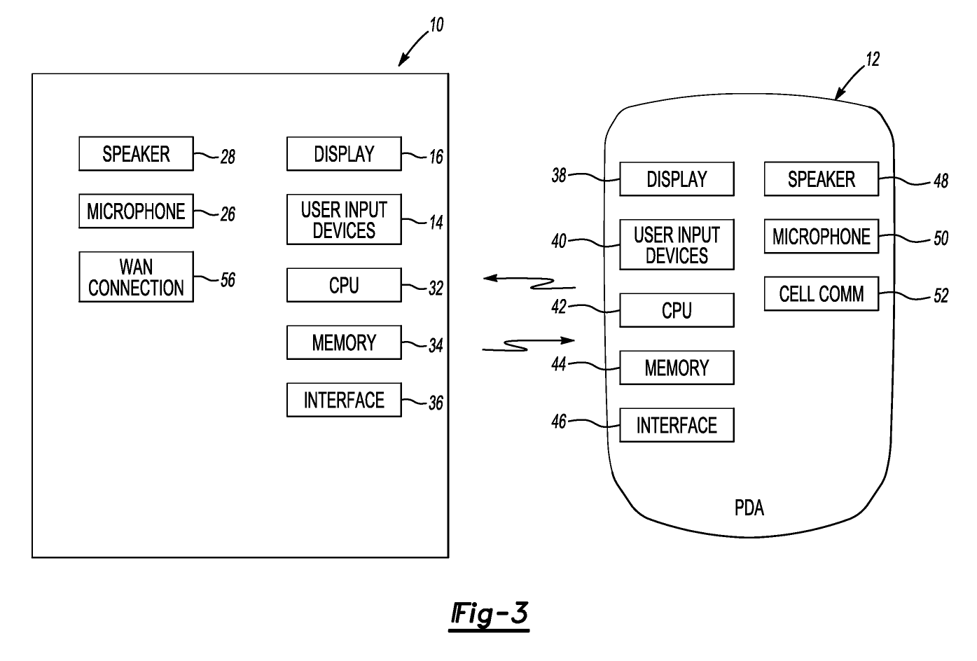

FIG. 3 schematically illustrates the components of the PDA 12 and computing device 10 (generically referring to PC 10a or in-vehicle system 10b). The computing device 10 includes at least several of following components: the display 16, user input devices 14, speaker 28 and microphone 26 (the PC 10a could also include the speaker 28 and microphone 26, as they usually do, and could also include the speech recognition and text to speech capabilities described above). The computing device 10 includes a CPU 32, memory 34 and an interface 36 (such as a Bluetooth communication circuit and/or USB connector). The memory 34 stores computer instructions which when executed by the CPU 32 performs the functions described herein.

The PDA 12 may include a display 38 and user input devices 40 (keys or keyboard, touchscreen, scroll wheels, etc). The PDA 12 includes a CPU 42, memory 44 and interface 46 complementary to the interface 36 on the computing device 10. The PDA 12 may include a speaker 48 and microphone 50 (such as for telephone applications) and includes a cellular communication circuit 52 (or satellite or other) for at least data transmission and preferably voice transmission. Contacts, calendar, tasks, email, media (music, video, books, audio, etc) are stored in memory 44. The memory 44 stores computer instructions which when executed by the CPU 42 performs the functions described herein.

In the first mode, software in memory 34 of the computing device 10 retrieves information from the memory 44 of the PDA 12, stores it in memory 34 of computing device 10, from which it is displayed on the display 16 (and/or read or played over speaker 28) and can be modified with user input devices 14 (or microphone 26). The modified information may be sent back to the PDA 12 for storage in memory 44 and/or retransmission (such as an email or meeting request, etc) by the PDA 12.

In the second mode of operation, the computing device 10 acts only as a “dumb” terminal for the PDA 12 via the interface 36. The computing device 10 receives information to display on display 16 (or read or play over speaker 28) from PDA 12, and the computing device 10 sends user inputs from the keyboard 14 (or other user input devices) or converted speech commands directly to the PDA 12 to be processed by the processor 42 of the PDA 12. The processor 42 of the PDA 12 acts on the information stored in its memory 44. In this mode, the user's information is more secure, since none of it is stored on the computing device 10; however, the user does not gain the advantage of the increased processing power of the computing device 10. This would be appropriate when using a public computing device 10 or someone else's computing device 10.

In either mode, the computing device 10 can also access telephone functions of the PDA 12 (for PDAs 12 with telephone functionality). For example, using the computing device 10, the user can access contacts stored in the PDA 12 and choose a phone number, which is then dialed by the PDA 12. The user can use the microphone 26 and speaker 28 of the computing device 10 to converse on the telephone call. Also, the PDA 12 informs the computing device 10 of incoming telephone calls (with caller id information displayed on display 16 or read via speaker 28), incoming email or sms or text messages, etc.

The PDA 12 can also make use of an internet connection 56 of the computing device 10, if the computing device internet connection is faster than that of the PDA 12.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method of accessing a mobile device including the steps of:
establishing a connection between a computing device and the mobile device;
accessing information on the mobile device with the computing device; and
controlling operation of the mobile device with the computing device.

2. The method of claim 1 further including the step of modifying the information on the mobile device with the computing device.

3. The method of claim 1 further including the steps of:
displaying the information on the computing device; and
transmitting the information from the mobile device.

4. The method of claim 1 further including the step of:
using a user input device on the computing device to send user input device signals to the computing device to modify the information on the mobile device as if the user input device were a user input device of the mobile device.

5. The method of claim 1 further including the step of:
using a user input device on the computing device to send user input device signals to the computing device to control operation of the mobile device as if the user input device were a user input device of the mobile device.

6. The method of claim 5 wherein the computing device is an in-vehicle system.

7. The method of claim 1 further including the step of displaying the information on the computing device in a higher resolution user interface than that of the mobile device.

8. The method of claim 7 wherein the information is displayed on the computing device as if it were a display of the mobile device.

9. The method of claim 8 wherein the computing device is an in-vehicle system.

10. The method of claim 9 wherein the display is installed in a vehicle.

11. The method of claim 1 wherein the mobile device includes a CPU receiving input device signals from an input device of the computing device, the CPU controlled by the input device signals.

12. The method of claim 1 wherein the computing device controls the mobile device to create and send email based upon input from a user input device on the computing device.

13. A computer readable medium storing instructions which when executed by a processor performs the steps of:
establishing a connection with a mobile device;
accessing information on the mobile device; and
controlling operation of the mobile device.

14. The computer readable medium of claim 13 further including instructions which when executed by the process performs the step of: modifying the information on the mobile device.

15. The computer readable medium of claim 13 further including instructions which when executed by the process performs the step of:
displaying the information on a display associated with and local to the processor; and
receiving the information from the mobile device.

16. The computer readable medium of claim 13 further including instructions which when executed by the process performs the step of:
receiving a user input device input signals; and
transmitting the user input signals to the mobile device.

17. The computer readable medium of claim 13 further including instructions which when executed by the process performs the step of: controlling the mobile device to create and send email based upon input from a user input device.
